(19) United States
(12) Patent Application Publication
(10) Pub. No.: US 2008/0042719 A1
(43) Pub. Date: Feb. 21, 2008

(54) Clock signal control method in the common clock and integrated circuit device

(75) Inventor: Naruyoshi Ando, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED

(21) Appl. No.: 11/656,387

(22) Filed: Jan. 23, 2007

(30) Foreign Application Priority Data
Jul. 11, 2006 (JP) 2006-190884

(51) Int. Cl. G06F 1/04

(52) U.S. Cl. 327/291

(57) ABSTRACT

The clock signal control method in the common clock system according to the present invention is used for controlling an output clock signal output externally from the integrated circuit device via the common clock system. According to the control method, a shift circuit for shifting the voltage level of the output clock signal output externally is provided, and the output clock signal output externally is controlled by shifting the voltage level using the shift circuit. It is possible, as a result, to securely output a clock signal with the proper waveform externally.

### CROSS-REFERENCE TO RELATED APPLICATION

This application is based upon and claiming the benefit of priority from the prior Japanese Patent Application No. 2006-190884 filed in Jul. 11, 2006, the entire contents of which are incorporated herein by reference.

### BACKGROUND OF THE INVENTION

1. Field of the Invention

The present invention relates to a technology for controlling clock signals output externally from an integrated circuit device via a common clock system.

2. Description of the Related Art

A common clock system is one of systems for data transfer. The common clock system is a system for data transfer in which both data transmitter and receiver are synchronized with a common clock signal.

FIG. 1 is a diagram showing a configuration of a conventional integrated circuit device compatible with the common clock system. In FIG. 1, 10 represents a conventional integrated circuit device (hereinafter referred to as “chip”) loaded on a printed circuit board (PCB), 11-13 are the transmission paths of a clock signal formed on the PCB, and 14 is a receiver circuit in a circuit into which a clock signal is input (the device serves as a load).

The chip (integrated circuit device) 10 is loaded with I/F that is compatible with the common clock system and has a configuration comprising an oscillator 10a, SDRAM 10b loaded with a PLL (Phase Locked Loop) circuit (PLL macro), a driver circuit 10c for amplifying and outputting a clock signal output from an X terminal of SDRAM 10b and a receiver circuit 10d for inputting and shaping the clock signal from the PCB.

The clock signal output from the X terminal of the chip 10 is input into the load device via the transmission paths 11 and 12. The transmission path 13 for inputting the clock signal on the transmission path 11 into the chip 10 (which causes feedback) is formed in consideration of the delay caused by the transmission path 11. As a result, the clock signal output from the chip 10 is returned as feedback as well as being input into the load device after a certain time has past. The PLL macro, by comparing a reference clock signal REF with the feedback clock signal or a clock signal obtained by dividing the frequency of the feedback clock signal, controls phases and the frequencies of those clock signals to ensure that they correspond to each other.

The clock signal output from the conventional chip 10 compatible with a common clock system might sometimes not have the full-swing oscillation. In other words, the clock signal does not reach VIL (Input Low Voltage: the maximum voltage recognized as Low in the load device side) or less, or does not reach VIH (Input High Voltage: the minimum voltage recognized as High in the load device side) or higher. This phenomenon is more likely to occur in the following cases:
(1) there is a large number of load devices to which the clock signal is input;
(2) there is a low-voltage LV-CMOS level transmission as represented by Mobile-SDRAM; and
(3) there is oscillation at and higher than a target frequency during a period of transition of PLL toward transmission stabilization.

### These cases frequently occur as a result of low voltage in the external I/O voltage and the existence of a high-speed I/F signal.

FIGS. 2A-2C are diagrams (timing charts) explaining a waveform change of the clock signal that did not have the full-swing oscillation. In FIGS. 2A-2C, the horizontal axis is the time scale and the vertical axis is the voltage scale.

If the clock signal output from the chip 10 does not have a full-swing oscillation on the PCB, the DC level of the waveform will make a transitional shift gradually toward High or Low. FIG. 2A is a timing chart in which the high voltage DC level shifted toward Low, FIG. 2B is a timing chart in which the low-voltage DC level shifted toward High, and FIG. 2C is a timing chart showing when both high voltage DC level and low voltage DC level shifted toward Low and High, respectively.

When such waveform transitions as shown in FIGS. 2A-2C occur, the feedback clock signal input into an FB terminal of the chip 10 might constantly exceed an I/O logical threshold level or constantly fall below the logical threshold level. The feedback signal is recognized as Low when it falls below the logical threshold level and is recognized as High when it exceeds the logical threshold level. Consequently, if the signal constantly exceeds or falls below the logical threshold level, the input of the feedback signal to the PLL macro will be a fixed value input of either High or Low. Accordingly, the PLL macro makes an erroneous judgment in this situation that the difference between the feedback signal and the reference clock signal REF was widened, and controls the VCO (Voltage Control Oscillator) in the PLL macro in the wrong direction. As a result, PLL itself falls to a self-oscillation frequency, and goes out of control.

FIG. 3 is a diagram explaining the waveform change of the clock signal actually output on the PCB. The waveform change in FIG. 3 is a case in which the high voltage DC level shifts toward Low. In FIG. 3, VIL (Input Low Voltage) and VIH (Input High Voltage) are the low voltage level and high voltage level required in the clock signal output on the PCB, respectively, and VTH (Threshold Voltage) is a logical threshold voltage.

If the feedback clock signal does not change within a range that includes the logical threshold voltage VTH—that is, if the clock signal changes only above the threshold voltage or changes only below the threshold voltage (the case in FIG. 3 is the latter)—the recognition result will not change. As a result, the PLL macro recognizes that the feedback clock signal is lost, and the clock signal cannot be controlled.

In order for the PLL macro to perform proper control, the input of a feedback clock signal with the proper waveform is required. In order to input a feedback clock signal with the proper waveform, the externally output clock signal of the PCB etc. has to have the proper waveform. Due in part to current trends, the probability that the waveform of the clock signal output externally will be improper has been increasing. For that reason, the secured external output of a clock signal with the proper waveform is of importance.

It should be noted that if the clock signal output from the chip 10 is input into a number of loads, the feedback clock signal to the chip 10 cannot be confirmed via external observation means (such as an oscilloscope) by monitoring the clock signal propagated externally. This is because using a probe for waveform observation or changing the wiring pattern on the PCB for waveform observation may influence the waveform quality and thus accurate observations cannot be performed. Therefore, in order to securely output a clock signal with the proper waveform externally, a particular emphasis has to be attached to this fact.

The technical reference documents include Japanese Patent Application Publication No. 2001-195354

### SUMMARY OF THE INVENTION

It is an object of the present invention to provide a technology for securely outputting a clock signal with the proper waveform externally.

The clock signal control method in the common clock system according to the present invention is a method used for controlling an output clock signal output externally from an integrated circuit device via the common clock system, which prepares a shift circuit for shifting the voltage level of the output clock signal and controls the output clock signal by shifting the voltage level using the shift circuit.

Note that it is desirable to provide the shift circuit in the integrated circuit device. It is also desirable for the shift circuit to have a configuration comprising an adjustment circuit for adjusting the amount of shift of the voltage level.

It is desirable for the shift circuit to have a configuration comprising a shift transistor for shifting the voltage level and a control transistor for controlling the shift transistor. It is desirable in addition for the control transistor to be a MOS transistor comprising a back gate, and for the adjustment circuit to adjust the amount of shift of the voltage level by a voltage applied to the back gate of the MOS transistor. Furthermore, it is desirable for the shift circuit to be driven by using at least one of a control voltage for determining the oscillation frequency in the PLL circuit loaded in the integrated circuit device, and a lock signal indicating whether the frequency is locked or not.

It is advisable that the shift circuit comprise a detection circuit for detecting any difference between an output clock signal output from the integrated device and an input clock signal returning to the integrated circuit device, and that the control transistor be driven by using a signal output from the detection circuit. It is also advisable that the detection circuit comprise a flip-flop for holding a logical value of the input clock signal via the output clock signal, and that the control transistor be driven by using a signal output from the flip-flop.

The integrated circuit device according to the present invention is assumed to be able to output a output clock signal externally via a common clock system, and comprises a shift circuit for shifting the voltage level of the output clock signal output externally and a driving circuit for driving the shift circuit.

Note that the shift circuit has a configuration comprising an adjustment circuit for adjusting the amount of shift of the voltage level.

In the present invention, a shift circuit for shifting the voltage level of the output clock signal output externally from the integrated circuit device is provided, and the output clock signal output externally is controlled by shifting the voltage level using the shift circuit as necessary.

There are some cases in which the amplitude of the output clock signal is insufficient due to the frequency or weight of the load etc. The voltage level of an output clock signal with insufficient amplitude is shifted by the shift circuit in the direction that will result in the proper amplitude. Consequently, it is possible to constantly maintain a proper clock signal output externally from the integrated circuit device. As a result, a factor causing the amplitude (waveform) of the clock signal to be improper in the past will no longer cause improper amplitude, facilitating circuit designing using an integrated circuit device.

### BRIEF DESCRIPTION OF THE DRAWINGS

FIG. 1 is a diagram showing a configuration of a conventional integrated circuit device compatible with the common clock;

FIGS. 2A-2C are diagrams showing a waveform change of the clock signal that did not have the full-swing oscillation;

FIG. 3 is a diagram showing a waveform change of the clock signal actually output on the PCB;

FIG. 4 is a diagram showing the configuration of the integrated circuit device of the first embodiment;

FIG. 5 is a diagram showing the processes of oscillation frequency stabilization;

FIG. 6A is a timing chart showing changes of various signal waveforms (conventional example);

FIG. 6B is a timing chart showing changes of various signal waveforms (present embodiment);

FIG. 7A is an enlarged view of the timing chart of FIG. 6 (conventional example);

FIG. 7B is an enlarged view of the timing chart of FIG. 6 (present embodiment);

FIG. 8 is a diagram explaining the configuration of the integrated circuit device according to the second embodiment;

FIG. 9 is a timing chart showing the change in the various signal waveforms in the second embodiment;

FIG. 10 is a diagram explaining the lock signal;

FIG. 11 is a diagram explaining the configuration of the integrated circuit device according to the third embodiment;

FIG. 12A is a graph showing the relation between the VCO control voltage and the waveform and frequency of the clock signal in different back bias voltages Vback (Vback=−0.2V);

FIG. 12B is a graph showing the relation between the VCO control voltage and the waveform and frequency of the clock signal in different back bias voltages Vback (Vback=+0.2V);

FIG. 13 is a diagram explaining the configuration of the integrated circuit device according to the fourth embodiment;

FIG. 14A is a timing chart of waveforms of various signals in the fourth embodiment (switch 1401 is opened);

FIG. 14B is a timing chart of waveforms of various signals in the fourth embodiment (switch 1401 is closed);

FIG. 15 is a diagram explaining the configuration of the integrated circuit device according to the fifth embodiment;

FIG. 16 is a timing chart of the waveforms of various signals in the fifth embodiment; and

FIG. 17 is a diagram explaining the operation of FF 1502.

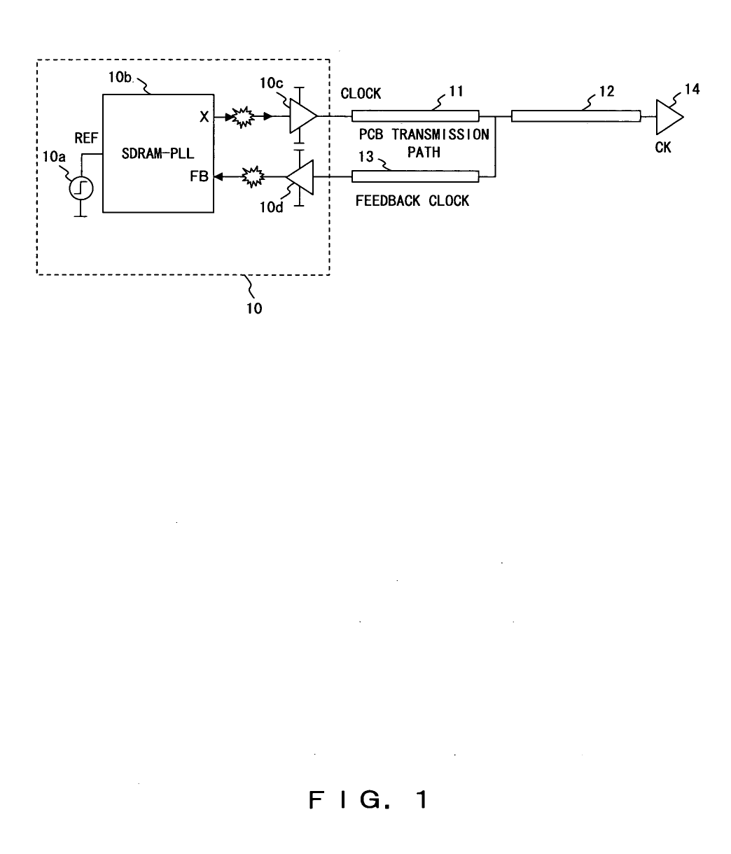

### DESCRIPTION OF THE PREFERRED EMBODIMENTS

In the following description, details of the embodiments of the present invention are set forth with reference to the drawings.

### First Embodiment

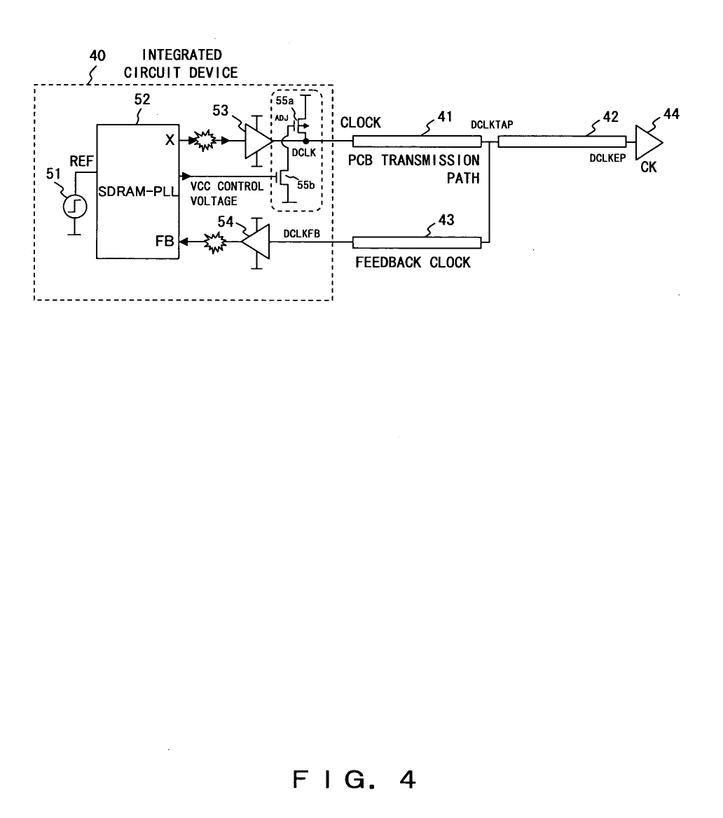

FIG. 4 is a diagram explaining the configuration of the integrated circuit device of the first embodiment. In FIG. 4, 40 represents an integrated circuit device (hereinafter referred to as “chip”) loaded on a printed circuit board (PCB), 41-43 are transmission paths of a clock signal formed on the PCB, and 44 is a receiver circuit in a circuit to which a clock signal is input (the device serves as a load).

The chip (integrated circuit device) 40 is loaded with an I/F supporting the common clock system and has a configuration comprising an oscillator 51 for generating a reference clock signal REF serving as a reference, an SDARM-PLL 52 loaded with a PLL circuit (PLL macro), a driver circuit 53 for amplifying and outputting the clock signal output from an X-terminal of the SDRAM-PLL 52, a receiver circuit for inputting and shaping the clock signal from the PCB, and a shift circuit 55 provided at the output side of the driver circuit 53.

The shift circuit 55 is a circuit for shifting the voltage level of a clock signal DCLK output from the driver circuit 53 so that the waveform of the clock signal DCLK becomes proper.

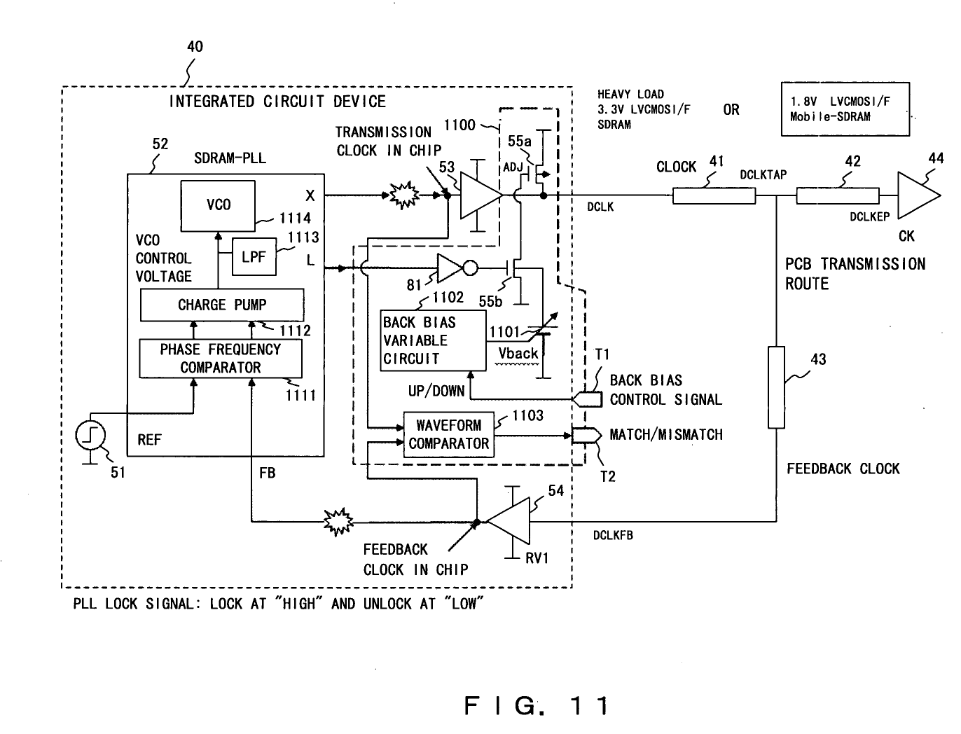

The PLL macro has the configuration shown in FIG. 11, although the configuration is not shown in FIG. 4. That is, the configuration comprises a phase-frequency comparator 1111, a charge pump 1112, an LPF (low pass filter, or loop filter) 1113, and a VCO 1114. In the following description, the explanation is provided under the assumption that the PLL macro has the configuration shown in FIG. 11 for descriptive purposes.

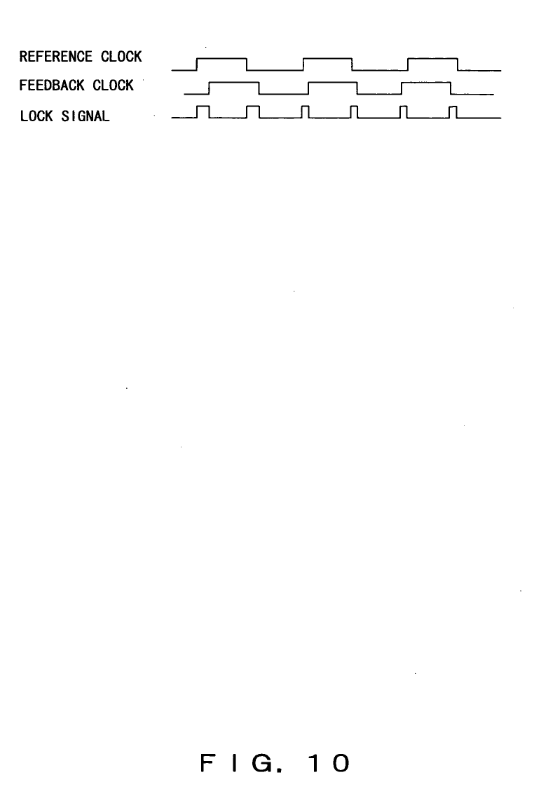

The phase-frequency comparator 1111 detects the difference in phase frequency between the reference clock signal REF and the feedback clock signal input from the FB terminal, and outputs two signals in accordance with the difference in phase frequency to the charge pump 1112. One of the two signals is a signal for increasing the oscillation frequency of VCO 1114 (UP signal) and another is a signal for decreasing the oscillation frequency (DOWN signal). Although not shown in the drawings, the comparator 1111 also outputs a clock signal as a detection result of the difference in phase frequency (FIG. 10).

The charge pump 1112 converts the UP and DOWN signals received from the phase-frequency comparator 1111 into voltage. LPF 1113 smoothes the volume applied from the charge pump 1112. The voltage after smoothing is applied to VCO 1114 as a VCO control voltage (VOC control signal), and VCO 1114 outputs a clock signal with a particular frequency according to the voltage. The clock signal is output from the X terminal to the driver circuit 53.

The shift circuit 55 comprises two MOS FETs 55a and 55b. The p-channel MOS FET (hereinafter referred to as “pMOS transistor”) 55a shifts the voltage level of the clock signal DCLK toward the supply voltage VCC, the supply voltage VCC is applied to its source, and its drain is connected to the wiring to which the clock signal DCLK is output. Its gate is connected to the drain of the n-channel MOS FET (hereinafter referred to as “nMOS transistor”) 55b. Since the supply voltage VCC is applied, the pMOS transistor 55a has to employ a high-voltage transistor (e.g. FH transistor) that is tolerant to the voltage VCC.

The nMOS transistor 55b is for controlling the operations (ON/OFF) of the pMOS transistor 55a. Its source is connected to the ground, and its gate is connected to the SDRAM-PLL 52. As a result, the configuration allows the control gate potential V (ADJ) of the pMOS transistor 55a via the gate potential—that is, it is a configuration allowing the control of the voltage level of the clock signal DCLK output from the chip 40. Since the supply voltage VCC is applied to the source of the pMOS transistor 55a, the voltage level of the clock signal DCLK is shifted to the supply voltage VCC level via this control process

The VCO control voltage applied to VCO 1114 becomes large as the frequency of the clock signal generated in VCO 1114 increases. On the basis of this fact, in the present embodiment the VCO control voltage is applied to the gate of the nMOS transistor 55b. As a result, the above control is essentially aimed at the high frequency domain. Since the VCO control voltage is used for controlling the nMOS transistor 55b, the PLL macro serves as a driving circuit of the shift circuit 55.

First, the circuit operation of a case in which the shift circuit 55 is not present is explained.

As the stop signal of PLL (not shown in the drawing) is removed and the VCO 1114 of the PLL macro gradually begins oscillating, the PLL macro compares the reference clock signal REF with the feedback clock signal received from the FB terminal. If the result of the comparison reveals that the feedback clock signal is delayed, a VCO control voltage for increasing the oscillation frequency is applied to the VCO 1114. In contrast, if the result reveals that the feedback clock signal is advanced, a VCO control voltage for decreasing the oscillation frequency is applied to the VCO 1114. Such control is implemented until the phase of the reference clock signal REF matches that of the feedback clock signal, and when the phase difference falls within an allowable error range, the PLL macro shifts to a stable frequency locked state. In the locked state, since comparison between the reference clock signal REF and the feedback clock signal is performed, some frequency fluctuation (ripple) occurs unitentionally.

In the feedback control system as represented by the PLL, it is probable that convergence to the target frequency might be over damping due to the delay element and the characteristics that follow in the feedback mechanism. In particular, in a circuit method (configuration) such that the feedback clock signal is not generated in the chip 40 and the signal is returned via the PCB, the manner of overlapping the reflected wave at a branching point varies widely depending on the shape of the splitting branches on the PCB transmission paths, the impedance of the transmission paths, the number of loads, etc. Since the waveform of the reflected wave is determined by the frequency of the transmitted clock signal DCLK and the signal intensity at the transmitting end, manipulation or prediction is possible to a certain extent. Under a transitional condition to stabilize the PLL frequency, however, it is difficult to accurately predict the transmission characteristics of the whole feedback loop because the frequency of the clock signal DCLK output to the transmission path changes. In particular, since internal circuits of the PLL macro are operating in a nonlinear manner until the PLL becomes locked, the calculation methods of phase margin and transmission gains are not established. However, it is not realistic to conduct a number of simulations in which the board configurations are changed in order to obtain those methods. For that reason, the accurate prediction of the manner of overlapping of the reflected wave is extremely difficult.

Before the frequency stabilizes, when the control is over-braking and the frequency is equal to or higher than the reference clock signal REF, the clock signal DCLK output to the transmission path 43 is likely to have a waveform that does not have the full-swing oscillation. In an extreme case, the clock signal DCLK will fall below VIL (Input Low Voltage)/VIH (Input High Voltage) with the receiver circuit 44 serving as a load, and the feedback clock signal output from the receiver circuit 54 (hereinafter referred to as “feedback clock signal FB” in order to differentiate it from the input feedback clock signal DCLKFB) after the input of the feedback clock signal DCLKFB will not change to exceed the logical threshold voltage VTH. As a result, the PLL macro will recognize that the feedback clock signal FB is lost, and the clock signal will no longer be able to be controlled.

Next, a circuit operation in which the shift circuit 55 is present is explained.

When a VCO 1114 in which the oscillation frequency and the VCO control voltage are proportional to each other is employed, the VCO control voltage is applied to the gate of the nMOS transistor 55b without modification. The use of a VCO control voltage is partly for the purpose of preventing the nMOS transistor 55b from being ON all the time.

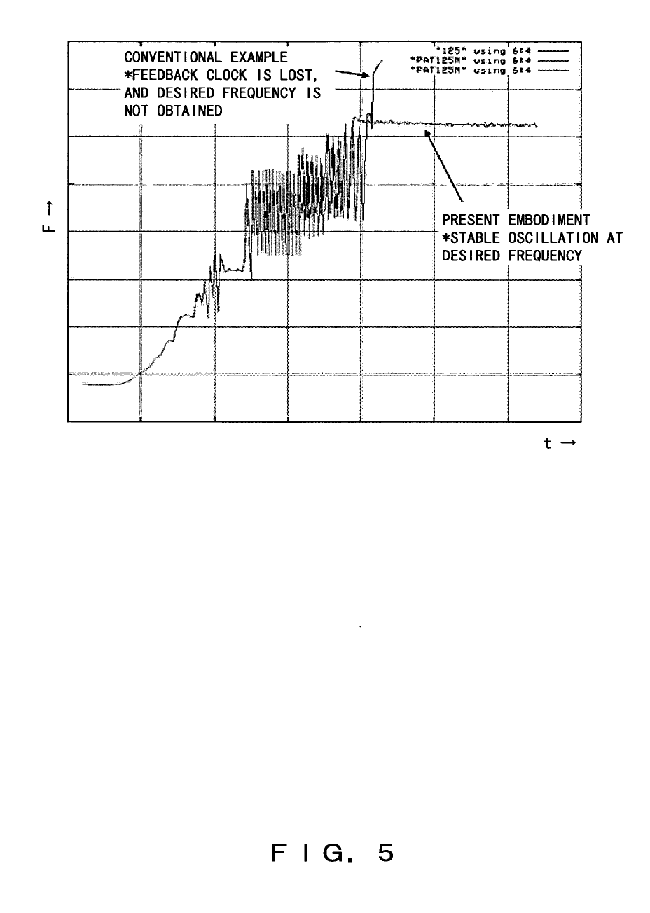

FIG. 5 is a diagram showing the processes of oscillation frequency stabilization. In FIG. 5, the horizontal axis is a time scale and the vertical axis is an oscillation frequency scale. With these axes, FIG. 5 represents the change in the oscillation frequency over time. In FIG. 5, to give a conventional example, the change in oscillation frequency in a case in which the shift circuit 55 is not present is also shown.

As shown in FIG. 5, in the conventional example, the feedback clock signal FB cannot be recognized and goes out of control in mid-course. On the other hand, the present embodiment (present invention) can continue being under control even after the conventional example goes out of control, and this state of control in which a desired frequency is stably generated is locked. Therefore, the drawing shows that by preparing the shift circuit 55 and driving it with a VCO control voltage, the proper waveform of the output clock signal DCLK is maintained.

The driving method employing the VCO control voltage has an undesirable driving condition in addition to a risk of using the VCO control voltage such that the temporal fluctuation of the VCO control voltage occurs around the threshold voltage VTH of nMOS transistor 55b. With this driving condition, the pMOS transistor 55a has a poor ON/OFF switching performance. However, even under these circumstances, the level shift of the clock signal DCLK is performed without any problems from the practical perspective as shown in FIG. 5. Accordingly, the locking operation is realized even under an external load condition in which PLL does not lock the frequency.

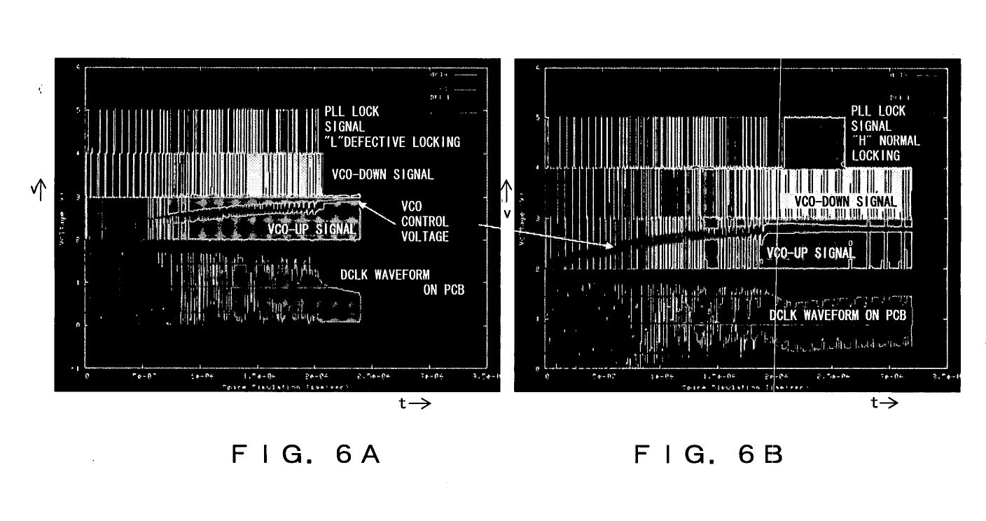

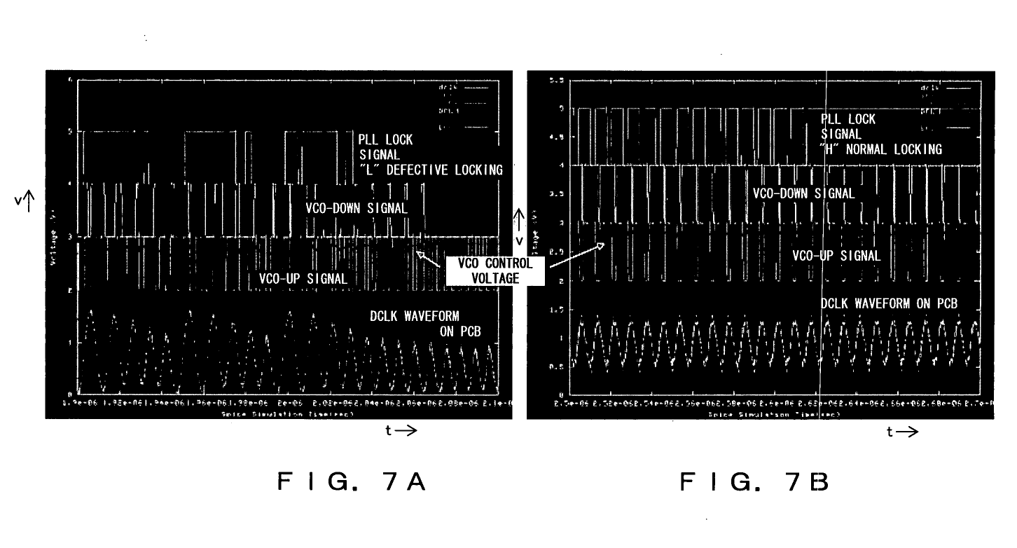

Next, with reference to FIGS. 6A-7B, details of the signal waveform in the chip 40 are set forth. FIG. 6A and FIG. 6B are timing charts showing the changes in various signal waveforms, and FIG. 7A and FIG. 7B are enlarged views of the timing charts. In order to depict the difference from the conventional example (difference caused by the presence/absence of the shift circuit 55), FIG. 6A and FIG. 7A show the various signal waveforms of the conventional example, and FIG. 6B and FIG. 7B show the various signal waveforms of the present embodiment.

The various signals, including the lock signal, the DOWN signal (“VCO-DOWN signal” in the drawings), the UP signal (“VCO-UP signal” in the drawings), the VCO control voltage, and the clock signal DCLK output on the PCB (“DCLK waveform on PCB” in the drawings) are shown in parallel on the same time scale.

In the conventional example, as shown in FIG. 6A, after a certain time has passed, the waveform of the clock signal DCLK shows an abrupt decline on the high-voltage side. The decline causes the PLL macro to lose the feedback clock signal FB, and even though the UP signal (a signal for increasing the oscillation frequency) has been continuously generated, the DOWN signal (a signal for decreasing the oscillation frequency) is not generated. FIG. 7A gives a clear picture of this change. Consequently, as shown in FIG. 6B and FIG. 7B, the conventional example significantly differs from the present embodiment (which has two signals being continuously generated) in the output signal (operation) of the phase-frequency comparator 1111.

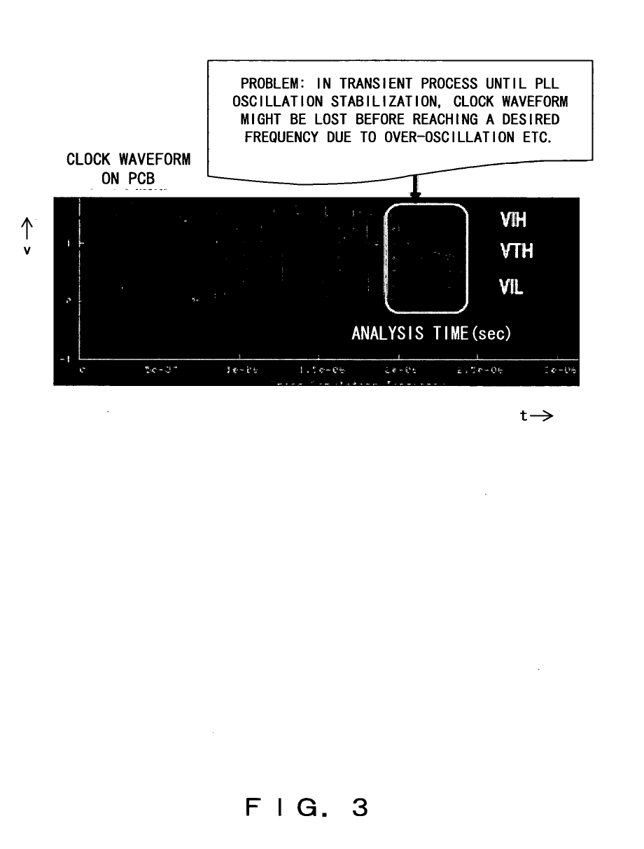

In the conventional example, with the clock signal DCLK that does not have the full-swing oscillation and stays barely on the logical threshold voltage VTH, when the upper envelope of the waveform exceeds the threshold voltage VTH, the control flow is such that “generation of the UP signal→increase the VCO 1114 oscillation frequency→reduce the clock signal DCLK waveform amplitude→delay in the feedback clock signal FB→generation of the UP signal→increase the VCO 1114 oscillation frequency→ . . . ”. In the worst case, when the upper envelope does not exceed the threshold voltage VTH, the control flow would be such that “generation of the UP signal→increase the VCO 1114 oscillation frequency→reduce the clock signal DCLK waveform amplitude→lose the feedback clock signal FB”, resulting in defective locking. As a result, as shown in FIG. 3, the oscillation frequency continues increasing and goes out of control.

The present embodiment, in contrast, as shown in FIG. 6B and FIG. 7B, locks around a point in which the conventional example goes out of control. The phase-frequency comparator 1111 alternately outputs the UP/DOWN signal immediately before the locking. The stability that enables such locking is realized by the center level of the clock signal DCLK amplitude being maintained at around ½ of the supply voltage VCC by the shift circuit 55. Accordingly, this locking proves that the shift circuit 55 operates properly.

Stable locking reduces the restrictions in the number and types of loads employed, the transmission path of the clock signal DCLK, or the frequency in the transmission path, and degrees of freedom in PCB design can be improved. This facilitates circuit design. A driver circuit with a lower driving capacity can be employed as the driver circuit 53. In addition, an increase in the clock frequency and a low voltage for the external I/O voltage (reduction in the amplitude of the clock signal DCLK) can be easily achieved. Because of the above features, the chip (integrated circuit device) 40 loading the shift circuit 55 is extremely versatile.

### Second Embodiment

In the first embodiment, VCO control voltage is used for driving the shift circuit 55. However, if wiring for outputting the VCO control voltage, which is crucial to the PLL macro, is installed, it is probable that undesirable situations such as noise being mixed in the VCO control voltage and an influence on the time constant of LPF 1113 that determines the characteristics that follow may arise. Hence, the second embodiment employs a lock signal instead of the VCO control voltage.

In the second embodiment, components that are the same as or essentially similar to those in the first embodiment are assigned the same reference numerals. Therefore, the explanation is provided with the focus on the parts that are different from the first embodiment. This also applies to the other embodiments explained later.

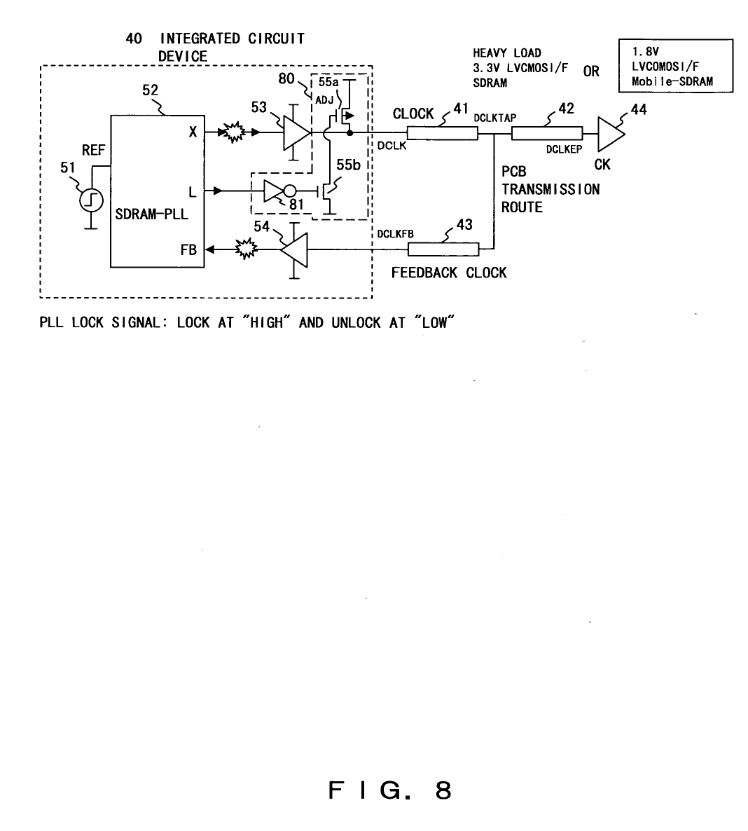

FIG. 8 is a diagram explaining the configuration of the integrated circuit device according to the second embodiment. The second embodiment comprises a shift circuit 80 instead of the shift circuit 55.

The shift circuit 80 has the circuit configuration of the shift circuit 50 in the first embodiment with the addition of an inverter 81 being connected to the gate of the nMOS transistor 55b. The inverter 81 receives an output of the lock signal from an L terminal of SDRAM-PLL 52. Since the nMOS transistor 55b is controlled by the lock signal via the inverter 81, the PLL macro serves as a driving circuit of the shift circuit 80.

The lock signal is a signal that is High when being locked and is Low when not being locked. As shown in FIG. 10, the signal is an exclusive OR of the reference clock signal REF (“reference clock” in the drawing) and the feedback clock signal FB (“feedback clock” in the drawing). Consequently, the signal repeats High and Low in half cycles. In the second embodiment, by inputting the lock signal to the gate of the nMOS transistor 55b via the inverter 81, the shift circuit 80 is driven under the condition in which the lock signal is Low, and the level shift of the clock signal DCLK is performed.

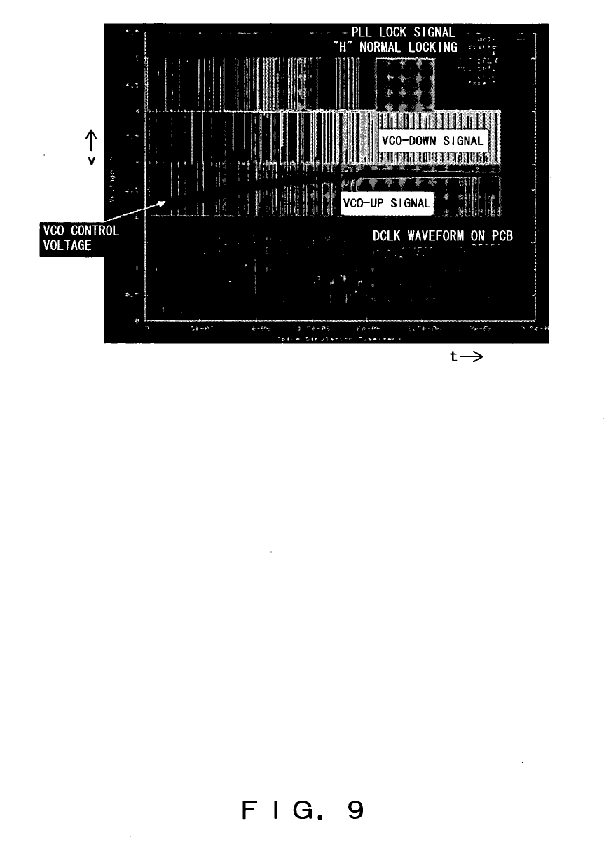

FIG. 9 is a timing chart showing the change in the various signal waveforms in the second embodiment. For the purpose of comparison with the first embodiment, the various signals that are the same as in FIG. 6, including the lock signal, the DOWN signal (“VCO-DOWN signal” in the drawings), the UP signal (“VCO-UP signal” in the drawings), the VCO control voltage, and the clock signal DCLK output on the PCB (“DCLK waveform on PCB” in the drawings), are shown in parallel on the same time scale. Consequently, the scale on the vertical axis is arbitrary.

As can be seen in FIG. 6B and FIG. 9, there is hardly any difference in the circuit operation between the first embodiment and the second embodiment. This is because the lock signal is used for driving (FIG. 10), causing pMOS transistor 55a to be ON for most of the time as in the first embodiment.

The PLL macro usually comprises a terminal for outputting the lock signal (the L terminal in this description). In practical circuit design, it is safer to use the lock signal than to use the VCO control voltage. There is also the advantage that if the PLL locks, the pMOS transistor 55a is turned OFF since the lock signal is High, and the circuit operation (the external AC specification in particular) no longer receives the influence.

### Third Embodiment

When the external I/O voltage becomes low—that is, when the amplitude of the clock signal DCLK is reduced—it is fundamentally difficult to shape the waveform of the clock signal DCLK that is propagated in the transmission path even though the driving capacity of the driver circuit 53 is improved. In many cases, the shape of the waveform is roughly determined by the branch shape of the PCB transmission path and the number of loads, and waveform shaping via adjustments other than increasing the external I/O voltage is difficult.

By shifting the voltage level using the shift circuit 55 or 80, it is possible to shape the waveform of the clock signal DCLK. However, as explained above, since the waveform of the clock signal DCLK is roughly determined by the branch shape of the PCB transmission path and the number of loads, the amount of shift to the shape of the waveform varies depending on the PCB where the chip 40 is loaded. The third embodiment enables fine adjustment of the amount of shift.

FIG. 11 is a diagram explaining the configuration of the integrated circuit device according to the third embodiment. First, with reference to FIG. 11, the difference in the configuration from that of the second embodiment is explained. In the third embodiment, a shift circuit 1100 is loaded instead of the shift circuit 80.

In the third embodiment, by adjusting the gate potential V (ADJ) of pMOS transistor 55a, fine adjustment of the amount of shift is performed. The gate potential (ADJ) is determined by the ON resistance of the nMOS transistor 55b. For that reason, an nMOS transistor 55b having a back gate (bulk) is employed, and the shift circuit 110 has a configuration that allows the voltage (back bias voltage) Vback applied to the back gate from the voltage source 1101 to be changed by a back bias variable circuit 1102. A waveform comparator 1103 for comparing the clock signal before being input into the driver circuit 53 with the waveform of the feedback clock signal FB output from the receiver circuit 54 and for outputting the comparison result is provided.

The back bias variable circuit 1102 varies the back bias voltage Vback applied by the voltage source 1101 in accordance with a back bias control signal. A terminal T1 for receiving the input of the back bias control signal is provided so as to vary the voltage Vback. In addition, in order to confirm the comparison result by the waveform comparator 1103, a terminal T2 for receiving the output is provided. As a result, in the third embodiment, the back bias voltage Vback can be adjusted while the comparison result of the waveform comparator 1103 is confirmed.

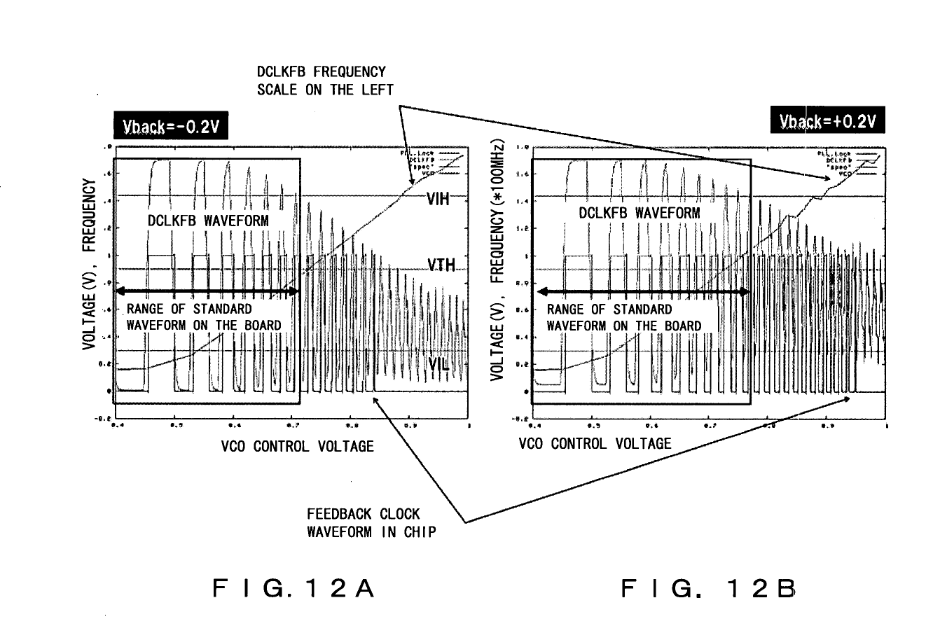

FIG. 12A and FIG. 12B are graphs showing the relation between the VCO control voltage and the waveform and frequency of the clock signal in different back bias voltages Vback. FIG. 12A is a case in which the back bias voltage Vback is −0.2V, and FIG. 12B is a case in which the back bias voltage Vback is +0.2V. The waveforms of the clock signals shown in the drawings are that of the feedback clock signal DCLKFB and that of the feedback clock signal FB. The waveform with a part where the high-voltage side exceeds VIH corresponds to the feedback clock signal DCLKFB, and the waveform without a part where the high-voltage side exceeds VIH corresponds to the feedback clock signal FB. The frequency of the clock signal DCLKFB—that is, the oscillation frequency of VCO 110—is denoted as “DCLK frequency”.

When the back bias voltage Vback is changed, the ON resistance of the nMOS transistor 55b changes. The change involves a change in the fate potential V (ADJ) of the pMOS transistor 55a, which results in the ON resistance of the pMOS transistor 55a being changed. Due to the change in the ON resistance, the amount of shift changes. As a result, as shown in FIG. 12A and FIG. 12B, both waveforms of the feedback clock signals DCLKFB and FB change by the back bias voltage Vback. In the examples shown in FIG. 12A and FIG. 12B, a waveform range within standards on board meeting the VIH/VIL standard in which the feedback clock signal DCLKFB is obtained is wider when the back bias voltage Vback is +0.2V.

As is clear from the above, it is possible to adjust the amount of shift via the back bias voltage Vback and to shape the waveform of the clock signal DCLK so as to satisfy the VIH/VIL standard of load. By shaping the waveform of the clock signal DCLK, its frequency can be further improved. This consequence contributes to the improvement of the data rate.

### Fourth Embodiment

In the first through third embodiments, the PLL circuit loaded on SDRAM-PLL 52 is used as a driving circuit of the shift circuits 55, 80 or 1100. By using a signal generated by the PLL circuit, the voltage level of the clock signal DCLK is shifted. Meanwhile, the fourth embodiment has a driving circuit that generates a signal for shifting the voltage level of the clock signal DCLK prepared in the shift circuit.

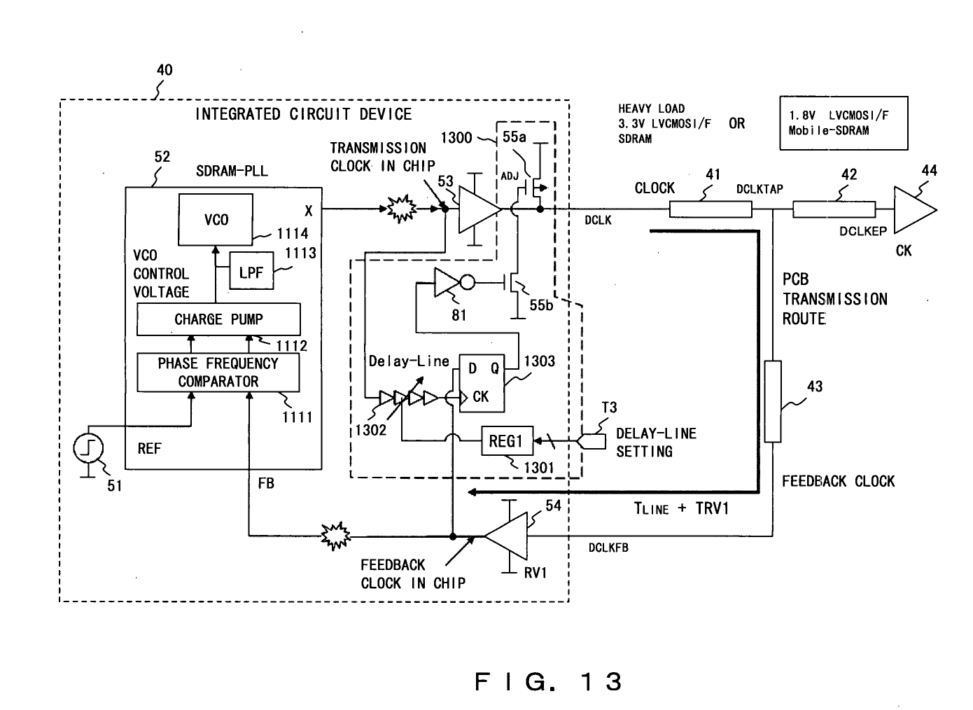

FIG. 13 is a diagram explaining the configuration of the integrated circuit device according to the fourth embodiment. First, with reference to FIG. 13, the difference in the configuration from that of the second embodiment is explained. In the fourth embodiment, a shift circuit 1300 is loaded instead of the shift circuit 80.

The shift circuit 1300 delays in a delay-line 1302 the clock signal output from the X terminal of SDRAM-PLL 52, and inputs the signal to a CK terminal of a D flip-flop (hereinafter referred to as “FF”) 1303. The feedback clock signal FB is input into a D terminal of FF 1303 and a signal output from a Q terminal of FF 1303 is input into the inverter 81. The delay-line 1302 employed is programmable and the amount of delay can be controlled by the data stored in a register 1301. A terminal T3 is prepared for rewriting the data stored in the register 1301. The data to be stored in the register 1301 corresponds to the propagation time required for the clock signal output from the X terminal to propagate the driver circuit 53, the transmission paths 41 and 43, and the receiver circuit 54.

The D flip-flop, as it is widely known, outputs a value of the signal input into the D terminal at the increase of the signal input into the CK terminal from the Q terminal. The output signal of the Q terminal is input into the gate of the nMOS transistor 55b via the inverter 81. For that reason, if the signal input into the D terminal at the increase of the signal input to the CK terminal is Low, then the voltage level is shifted by the pMOS transistor 55a. When the data corresponding to the propagation time is stored in the register 1301 and the clock signal is delayed for the propagation time, the signal input into the D terminal at the increase of the signal input into the CK terminal is High in normal operation.

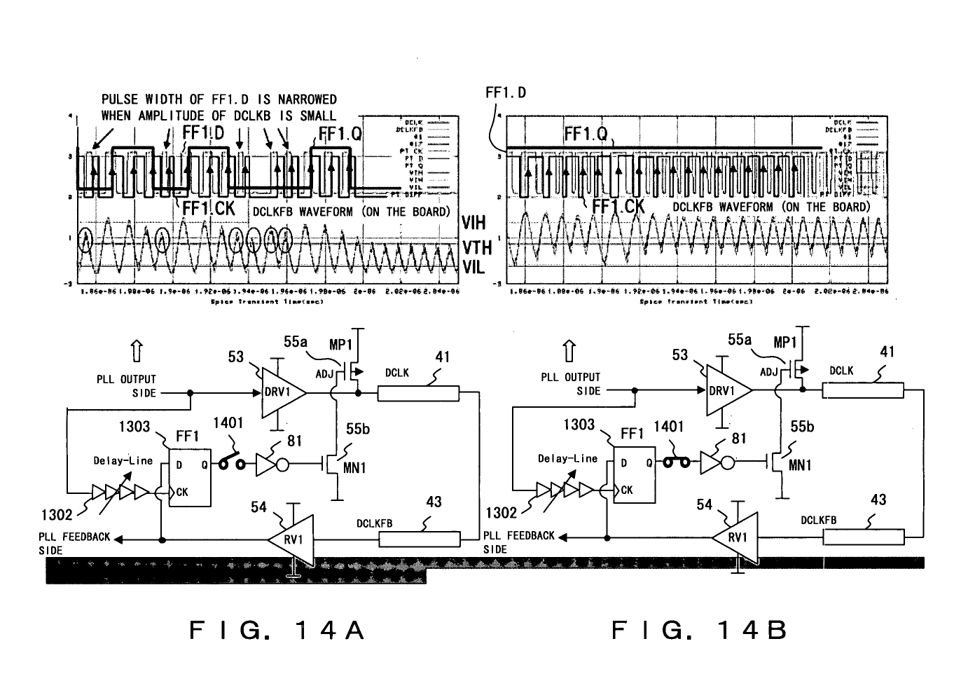

FIG. 14A and FIG. 14B are timing charts of waveforms of various signals in the fourth embodiment. FIG. 14A is a case in which a switch 1401 provided between the Q terminal of FF 1303 and the inverter 81 is opened, and FIG. 14B is a case in which the switch 1401 is closed. The various signals include an input signal to the D terminal of FF 1301 (“FF1.D” in the drawing), the input signal to the CK terminal (feedback clock signal FB described as “FF1.CK” in the drawing), the output signal from the Q terminal (“FF1.Q” in the drawing), and the feedback clock signal DCLKFB (“DCLKFB waveform” in the drawing).

As shown in FIG. 14A, if the clock signal DCLK has insufficient amplitude due to high speed etc. (if the high-voltage side shifts toward Low in this example), the pulse width where the feedback clock signal FB (FF1.CK) and the clock signal from the X terminal (FF1.D) are High becomes narrow. As a result, a situation occurs such that the signal input into the D terminal at the increase in the signal input to the CK terminal is Low. The situation occurs from the circled points in the feedback clock signal DCLKFB in FIG. 14A.

In such a situation, the signal output from the Q terminal is Low, and the pMOS transistor 55a is turned ON. Consequently, when the switch 1401 is closed so that the output signal from the Q terminal is input into the inverter 81, the voltage level has to be shifted to the supply voltage VCC side. As a result, as shown in FIG. 14B, the output signal from the Q terminal constantly maintains High. A proper clock signal DCLK is always output from the chip 40.

### Fifth Embodiment

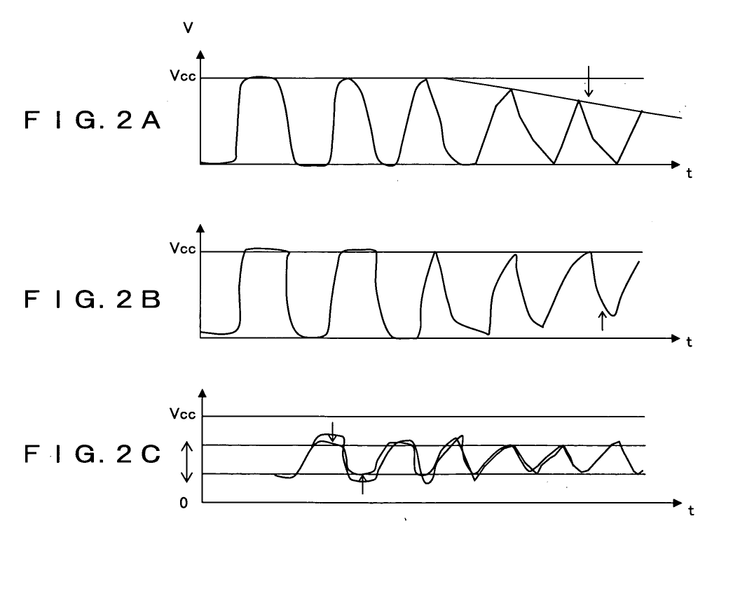

In the first through fifth embodiments, the high-voltage side of the clock signal DCLK is shifted to the supply voltage VCC side. However, it is also probable that the low-voltage side of the clock signal DCLK will shift toward High (FIG. 2B). In view of this probability, the fifth embodiment can handle the shift of the low-voltage toward Low. By handling such shifts, the proper clock signal DCLK can be further ensured to be constantly output

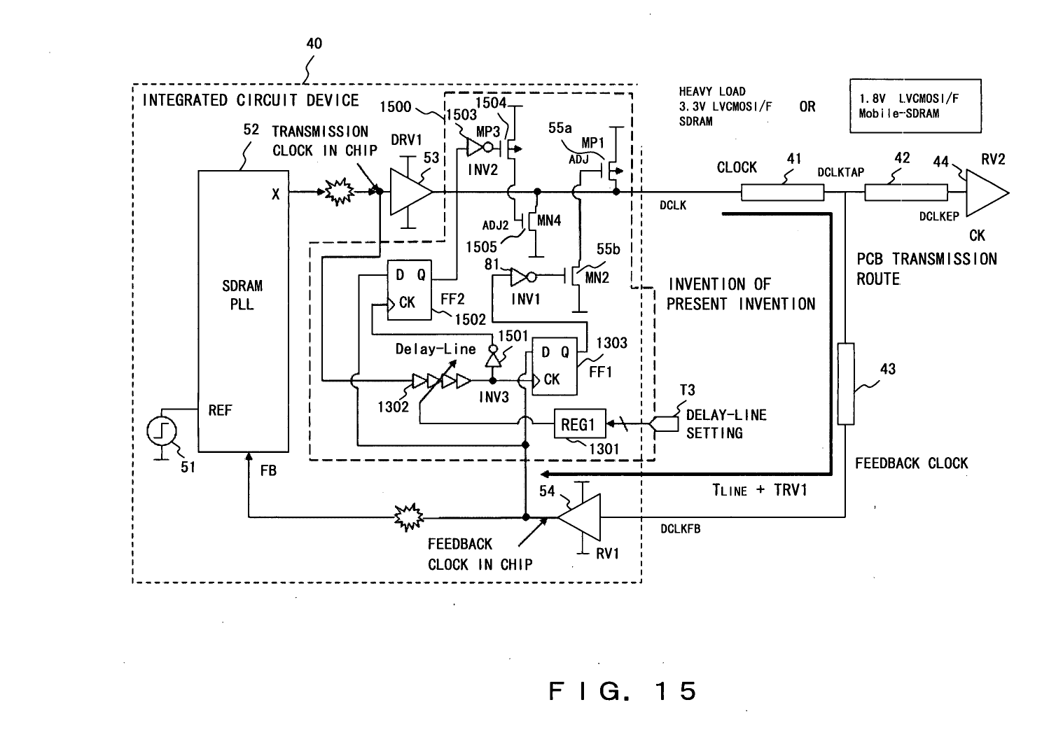

FIG. 15 is a diagram explaining the configuration of the integrated circuit device according to the fifth embodiment. First, with reference to FIG. 15, the difference in the configuration from that of the fourth embodiment is explained. The fifth embodiment comprises a shift circuit 1500 instead of the shift circuit 1300.

The shift circuit 1500 comprises inverters 1501 and 1503, a D flip-flop (hereinafter referred to as “FF”) 1502, a pMOS transistor 1504, and an nMOS transistor 1505 in addition to the components of the shift circuit 1300. The feedback clock signal FB is input into the D terminal of FF 1502, and a main signal in the delay-line 1302 is input into the CK terminal of FF 1502 via the inverter 1501. The output signal from the Q terminal is input into the gate of the pMOS transistor 1504 via the inverter 1503. The supply voltage VCC is applied to the source of the pMOS transistor 1504 and its drain is connected to the gate of the nMOS transistor 1505. The drain of the nMOS transistor 1505 is connected to the wiring to which the clock signal DCLK is output, and its source is connected to the ground. As a result, the nMOS transistor 1505 functions to shift the clock signal DCLK toward the ground, and the pMOS transistor 1504 functions to control the nMOS transistor 1505.

The output signal of the Q terminal of FF 1502 is input into the gate of the pMOS transistor 1504 via the inverter 1503. The output signal of the delay-line 1302 is input into its CK terminal via the inverter 1501, and the feedback clock signal FB is input into the D terminal. When the low-voltage side of the clock signal DCLK shifts toward High, the amplitude of the feedback clock signal DCLKFB that falls below the logical threshold voltage VTH is reduced, and the amplitude that exceeds the voltage VTH is increased. FF 1502, like FF 1303, utilizes that feature, and is used for detecting the shift of the low-voltage side toward High. The amplitude below the voltage VTH is reflected to a signal input into the CK terminal, and the amplitude exceeding the voltage VTH is reflected to a signal input into the D terminal. Accordingly, in abnormal operation, the High signal is output from the Q terminal.

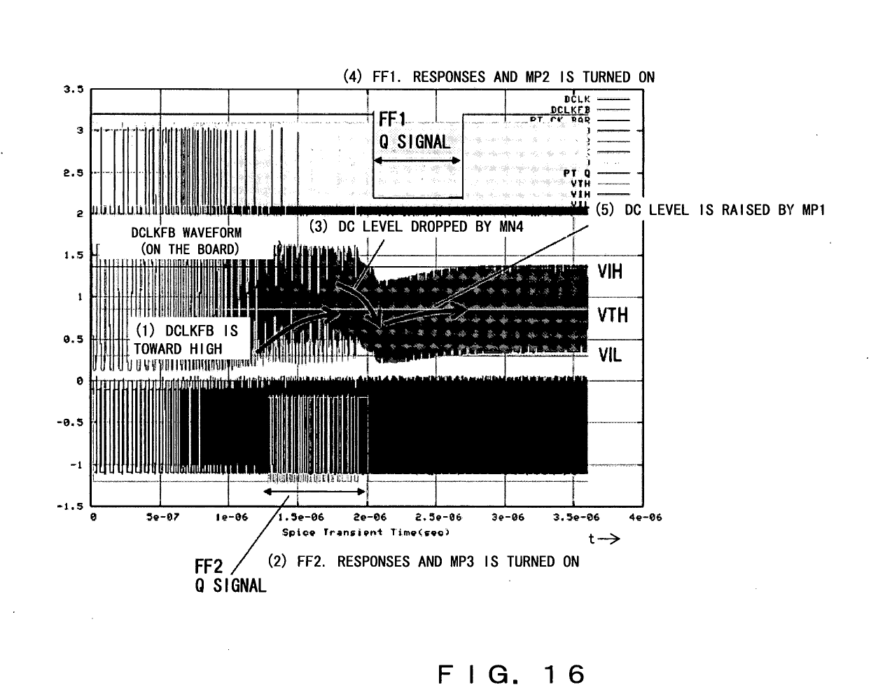

FIG. 16 is a timing chart of the waveforms of various signals in the fifth embodiment. The various signals include a signal output from the Q terminal of FF 1303 (“FF1Q signal” in the drawing), the feedback clock signal DCLKFB (“DCLKFB waveform (on the board)” in the drawings), and a signal output from the Q terminal of FF 1502 (“FF2Q signal” in the drawing) and are shown in each of the rows.

As shown in FIG. 16, the feedback clock signal DCLKFB has its low-voltage side shifted toward High after a certain time period. As a result, the signal output from the Q terminal of FF 1502 becomes High. When the signal becomes High, the pMOS transistor (“MP3” in the drawing) 1503 is turned ON. Consequently, the nMOS transistor (“MN4” in the drawing) 1505 is turned ON, and the low-voltage side is shifted toward Low. Afterwards, since the high voltage of the feedback clock signal DCLKFB shifts toward Low, the signal output from the Q terminal of FF 1303 is Low, causing the nMOS transistor to be turned ON (“MN2” in the drawing). As a result, the pMOS transistor 55a is turned ON, and the high-voltage side is shifted toward High. Subsequently, the feedback clock signal DCLKFB is stable. Therefore, it is apparent that the shift of the voltage toward Low and the shift toward High function in a complementary manner, and gradually effects a stable state.

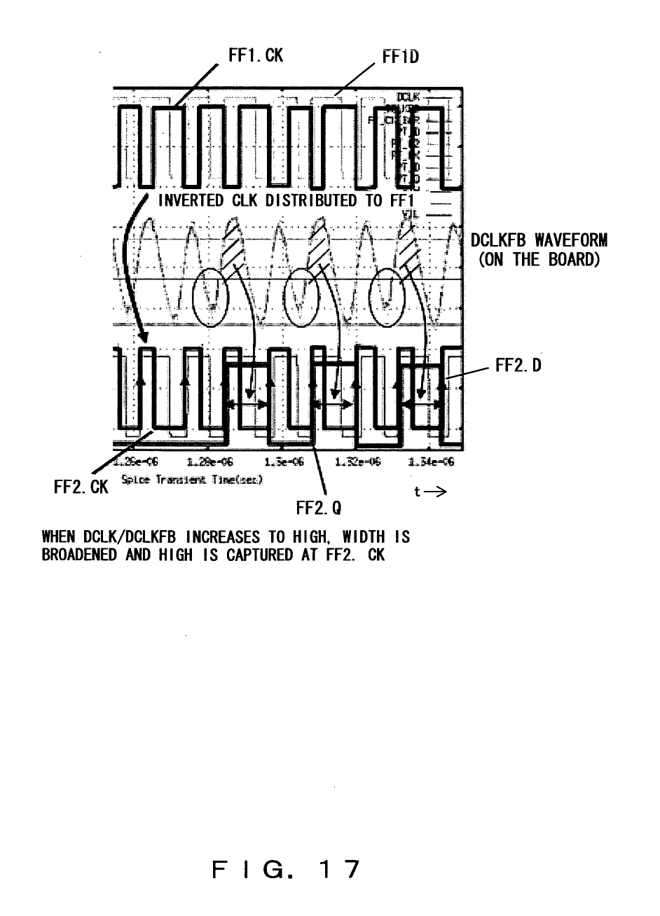

FIG. 17 is a diagram explaining the operation of FF 1502. In FIG. 17, in order to explain the operation, an input signal to the D terminal of FF 1303 (“FF1.D” in the drawing), an input signal to the CK terminal (the feedback clock signal DCLKFB described as “DCLKFB waveform (on the board)” in the drawing), an input signal to the D terminal of FF 1502 (“FF2.D” in the drawing), an input signal to the CK terminal (“FF2.CK” in the drawing) and an output signal from the Q terminal (“FF2.Q” in the drawing) are shown in parallel on the same time scale.

The waveform of the input signal to the CK terminal of FF 1502 is an inversion of the waveform of the input signal to the CK terminal of FF 1303. The waveform of the input signal to the D terminal of FF 1502 is the same as the waveform of the input signal to the D terminal of FF 1303. The circuit operation of FF 1303 is the same as that of the fourth embodiment, and therefore the explanation is omitted.

When the low-voltage side of the feedback clock signal DCLKFB shifts toward High, the amplitude of the feedback clock signal DCLKFB that falls below the logical threshold voltage VTH is reduced, and the amplitude that exceeds the voltage VTH is increased. Therefore, at the increase of the input signal to the CK terminal, a situation occurs such that the input signal to the D terminal becomes High. The circled parts on the graph of the clock signal DCLKFB in FIG. 17 indicate the origination of this situation.

In such a situation, the signal output from the Q terminal of FF 1502 becomes High, and the pMOS transistor 1504 is turned ON. The nMOS transistor 1505 is turned ON and the DC level of the clock signal DCLKFB is shifted toward the ground (Low). This prevents the low voltage of the clock signal DCLKFB from being left shifted toward High.

In the present embodiment, the clock signal is shifted only toward High or both toward High and toward Low; however, the shift can be made only toward Low. Additionally, in the first, second, third, fourth and fifth embodiments, a waveform comparator 1103 might be provided so as to confirm the comparison result of the waveform of the clock signal before it is input into the driver circuit 53 with the waveform of the feedback clock signal FB output from the receiver circuit 54. Alternatively, the embodiments might have a configuration that allows the adjustment of the amount of shift by controlling the back bias voltage of a MOS transistor for control.

In the fourth and fifth embodiments, a driving signal is generated by using a clock signal in the chip 40. The circuit configuration for generating the signal is not limited to the ones shown in FIG. 13 and FIG. 15. Various modifications can be made or a very different configuration can be employed if necessary.

What is claimed is:

1. A clock signal control method used for controlling an output clock signal output externally from an integrated circuit device via a common clock system, comprising:
preparing a shift circuit for shifting the voltage level of the output clock signal; and
controlling the output clock signal via the shift of the voltage level using the shift circuit.

2. The clock signal control method in the common clock system according to claim 1, wherein
the shift circuit is provided within the integrated circuit device.

3. The clock signal control method in the common clock system according to claim 1, wherein
the shift circuit has a configuration comprising an adjustment circuit for adjusting the amount of shift of the voltage level.

4. The clock signal control method in the common clock system according to claim 1, wherein
the shift circuit has a configuration comprising a shift transistor for shifting the voltage level and a control transistor for controlling the shift transistor.

5. The clock signal control method in the common clock system according to claim 4, wherein
the control transistor is a MOS transistor comprising a back gate, and
the adjustment circuit adjusts the amount of shift of the voltage level via a voltage applied to the back gate of the MOS transistor.

6. The clock signal control method in the common clock system according to claim 1, wherein
the shift circuit is driven by using at least one of a control voltage for determining a oscillation frequency in a PLL circuit loaded in the integrated circuit device and a lock signal indicating whether the frequency is locked or not.

7. The clock signal control method in the common clock system according to claim 1, wherein
the shift circuit comprises a detection circuit for detecting difference between the output clock signal output from the integrated device and an input clock signal returning to the integrated circuit device, and
the control transistor is driven by using a signal output from the detection circuit.

8. The clock signal control method in the common clock system according to claim 7, wherein
the detection circuit comprises a flip-flop for holding a logical value of the input clock signal via the output clock signal, and
the control transistor is driven by using a signal output from the flip-flop.

9. An integrated circuit device, which enables to output a output clock signal externally via a common clock system, comprising:
a shift circuit for shifting a voltage level of the output clock signal output externally; and
a driving circuit for driving the shift circuit.

10. The integrated circuit device according to claim 9, wherein
the shift circuit has a configuration comprising an adjustment circuit for adjusting an amount of shift of the voltage level.

11. The integrated circuit device according to claim 9, wherein
the shift circuit has a configuration comprising a shift transistor for shifting the voltage level, and a control transistor for controlling the shift transistor.

12. The integrated circuit device according to claim 11, wherein
the control transistor is a MOS transistor comprising a back gate, and
the adjustment circuit adjusts the amount of shift of the voltage level via a voltage applied to the back gate of the MOS transistor.

13. The integrated circuit device according to claim 9, wherein
the driving circuit is a PLL circuit loaded in the integrated circuit device, and
the shift circuit is driven by using at least one of a control voltage for determining an oscillation frequency and a lock signal indicating whether the frequency is locked or not.

14. The integrated circuit device according to claim 9, wherein
the driving circuit is a circuit for detecting difference between an output clock signal output from the integrated device and an input clock signal returning to the integrated circuit device and for outputting the detection result.

15. The integrated circuit device according to claim 14, wherein
the driving circuit comprises a flip-flop for holding a logical value of the input clock signal via the output clock signal, and
the control transistor is driven by a signal output from the flip-flop.
